(19) United States
(12) Patent Application Publication
(10) Pub. No.: US 2005/0171800 A1
(43) Pub. Date: Aug. 4, 2005

(54) Menu-order selection support system, data center and eating-house system

(75) Inventor: Yuji Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/873,134

(22) Filed: Jun. 23, 2004

(30) Foreign Application Priority Data
Feb. 4, 2004 (JP) 2004-027522

(51) Int. Cl. G06F 17/60

(52) U.S. Cl. 705/1; 705/15

(57) ABSTRACT

The present invention relates to a menu-order selection support system for supporting a person in ordering an item by selecting and providing food and drink menus at an eating-house such as a restaurant and the like. The present invention allows a user to perform health management wherever the user takes a meal, even if the user takes a meal at multiple places. The present invention includes a data center for managing personal data including preference information indicating preference, harmful foodstuff information indicating a forbidden foodstuff, and health management information for managing intakes, for each user, and providing the information in response to an access, and an eating-house systems for receiving customer's personal data from the data center and providing the customer with a menu that matches the customer's personal data, where the eating-house system is connected to the data center via a communication line.

### BACKGROUND OF THE INVENTION

1. Field of the Invention

The present invention relates to a menu-order selection support system for supporting a person in ordering an item by selecting and providing food and drink menus at an eating-house such as a restaurant and the like, a data center for managing effective information for selecting menus, and an eating-house system for supporting an eating-house in providing menus and supporting a person in ordering an item with information provided from the data center.

2. Description of the Related Art

Placing an order at an eating-house such as a restaurant is a kind of contract considered as very significant action. Once an order is placed, it is hard or difficult to cancel or change the order, as an order is a contract.

However, in this general aspect of transaction, users actually have to select an item from a list of items (food and drink) having no idea about the ingredients of the items.

A wrong order would result in a situation that a user cannot have the item because the user does not like it. A wrong order accompanied by an allergenic foodstuff may seriously affect the user's life.

With no information on customer's preference, eating-houses have had to provide customers with their menus just on the basis of general information. Therefore, they also have had to advertise their new menus randomly with their lists of users.

With health-consciousness in vogue, more and more eating-houses display such information as calorie and the like. This information is insufficient for actual nutrition management. Nutrient information is an example of such insufficient information. What is needed is such information as how much of which nutrient or what ingredient is contained in an item. However, a menu with all such information is inconvenient to read. Although menu-supporting systems using a computer and the like (four typical examples are shown below) have been developed to solve these problems, they cannot provide sufficient services.

(1) Japanese Patent Laid-Open No. 11-31175 (Patent Document 1)

Summary: Based on various conditions of customers and their previous orders, a menu with well nutrient balance is provided.

System configuration: A networked home delivery configuration including a purchasing part, an order entry center (including a user terminal), a food processing part, and a delivery center.

Services: This is a food supplier's service, and food orders are limited to be placed from a house. The menu has some division to allow a user to select items according to the user's preference such as hot, mild or the like (a user can merely select a hot flavored curry, a mild flavored curry, or the like). All information is displayed on the menu (a large volume of information will be displayed including preference information). This system has a function to suggest a user to change an order based on the mean value of calorie intakes or intakes of each nutrient taken by the user in the last one month.

(2) Japanese Patent Laid-Open No. 2003-16191 (Patent Document 2)

Summary: Based on information on allergy and preference, there is provided information on food with well-balanced nutrient without an allergen.

System configuration: A network connecting each home terminal, the menu-planning system, and a food supplier.

Menu display: A menu is created with consideration of allergy, and preference information. This system mandatorily creates a menu. With no function of storing data obtained, the system creates a menu for a single occasion just according to a therapeutic diet or weight-controlling diet without taking account of taken contents of nutrients or a taken calorie.

(3) Japanese Patent Laid-Open No. 0.2003-99539 (Patent Document 3)

Summary: There is provided a system that refers to health information from a medical institution and provides a customer with advisory information on a menu at an eating-house.

System configuration: A closed system including a menu terminal, an eating-house terminal, a head office terminal, and a food head office. This system can also cooperate with a hospital terminal. An instruction goes just one-way from a hospital terminal toward the food head office.

Services: All the items on a menu of an eating-house are displayed and an order is placed. If the order has a value higher than an allowable intake in a day (calorie, nutrient), advisory information is returned and then the order is changed according to the advisory information and placed again. This system has an option of changing an amount of an ingredient, if desired. Since this system is a closed system in a single eating-house, a user first has to enter the last taken food and drink in the system.

(4) Japanese Patent Laid-Open No. 2001-30666 (Patent Document 4)

Summary: There is provided a system that orders the food selected by a user from detailed menu information including ingredients, a calorie intake, a content of each nutrient, and so on.

System configuration: A closed configuration in an eating-house, including a portable information terminal (either a customer's terminal or a restaurant's terminal), an electronic register (for accounting or discounting calculation based on the number of visit), a personal computer for a kitchen (used for managing the current process, which prepares an ordered food principally with no errors, and for managing a waiting time), and a server at an eating-house that are connected via a wireless LAN.

Menu-display: Only a calorie and a content of each nutrient are displayed. A menu with restricted diet (need to be manually specified by a user) is a fixed menu specific to a disease or a symptom. A server at an eating-house stores a feedback with a comment (for changing an order at the next visit), table terminal management (for managing an additional order and for calculating a waiting time), the number of visit (for changing a discount rate for the next time), and paid amount.

Data including likes, dislikes, allergy, an allowable calorie, and the like (hereinafter referred to as “personal data”) has been taken by conversations and stored by human memory. Uncertain information thus obtained has lead mistakes. There is a system for utilizing this data in a database to be managed at a home delivery business (see Patent Document 1 and 2) or at an eating-house (see Patent Document 3 and 4) for a certain health management.

However, every system is limited to be used by a business. When a person has a meal at another eating-house or has a meal prepared by him/herself, those meals are not managed by the system and the accumulated data of a calorie and a content of each nutrient in the system goes invalid. This type of conventional system is inconvenient in everyday life, only increasing the number of items in a menu served at a hospital (meals prepared by calculating calorie and the content of each nutrient) and creating an eating out system (at very limited places). That is to say, this system has served a ready-made menu or a menu limited to a single eating-house, a meal taken at a limited place, and the like, which are almost the same as those served at hospitals.

### SUMMARY OF THE INVENTION

In view of the above situation, the present invention intends to provide a menu-order selection support system for allowing a person to perform health management regardless of place even if a person eats at plural eating-houses, a data center preferable for the system, and an eating-house system.

A menu-order selection support system according to the present invention includes:
a data center that manages personal data including preference information indicating preference, harmful foodstuff information indicating a forbidden foodstuff, health management information for managing intakes, for each user, and provides the information in response to an access; and
an eating-house system that is connected to the data center via a communication line and provides, upon receiving personal data of a customer from the data center, the customer with a menu that matches the personal data of the customer.

The data center may manage eating-house data including menu information that indicates ingredients and their contents in an item for each item on a menu at each eating-house along with the personal data, and
the eating-house system may provide, upon receiving personal data of a customer and eating-house data of its own from the data center, a menu that matches both the eating-house data of its own and the personal data of the customer.

The eating-house system may manage eating-house data of its own including menu information indicating ingredients and their contents in an item for each item on a menu and provides, upon receiving personal data of a customer from the data center, a menu that matches both the eating-house data of its own and the personal data of the customer.

In the above system, the menu information may include optional information indicating a substitute for an ingredient of an item on a menu and a content of the substitute in the item, and
the eating-house system may provide a menu that matches personal data of a customer and is selected from the menu information including the optional information.

In the menu-order selection support system according to the present invention may include:
group recognition means for recognizing that a plurality of customers belong to the same group; and
warning means for warning, when a customer of a plurality of customers in a group orders an item containing a foodstuff harmful to a customer of the plurality of customers in the same group, that the harmful foodstuff is contained in the item.

In the above menu-order selection support system, the health management information may include information on an allowable intake and a previous intake for each of a plurality of durations with different time lengths, and
the eating-house system may provide a customer with an allowable intake for the customer's current meal calculated from the customer's previous intake and the allowable intake for the plurality of durations.

In the above menu-order selection support system, the eating-house system may include:
input means for inputting a customer's intake at the eating-house; and
feedback means for sending the intake input from the input means to the data center to update the customer's health management information.

Further, the eating-house system may include:
input means for inputting a customer's evaluation of a current meal at the eating-house; and
feedback means for sending the input evaluation to the data center to update the customer's preference information.

Furthermore, the eating-house system may have:
visit information including preference information of the eating-house's customer in addition to the menu information;
input means for inputting a customer's evaluation of a current meal at the eating-house; and
feedback means for sending the input evaluation to the data center to update the customer's preference information and the visit information to the eating-house.

In the above menu-order selection support system, the eating-house system may include customer retrieval means for retrieving a target customer of the eating-house's advertisement on the basis of the visit information as to the eating-house.

The menu-order selection support system may further include, in addition to the data center and the eating-house system, a terminal that records personal data in and/or uses personal data from the data center.

A data center according to the present invention includes:
data management means for managing personal data including preference information indicating preference, harmful foodstuff information indicating a forbidden foodstuff, and health management information for managing intakes, for each user; and
data providing means for providing customer's personal data in response to an access via a communication line from an eating-house system that provides a menu to a customer.

An eating-house system according to the present invention includes:
data obtaining means for obtaining personal data of a customer from a data center by accessing the data center via a communication line, the data center managing personal data including preference information indicating preference, harmful foodstuff information indicating a forbidden foodstuff, and health management information for managing intakes, for each user; and
menu providing means for providing the customer with a menu that matches the personal data of the customer.

According to the present invention, a central management of personal data at a data center allows every eating-house to provide the same processing. With an area for storing a calorie intake and an intake for each nutrient in personal data, the calorie intake and the intake for each nutrient can be managed.

Therefore, a user is provided with a service that allows meal data to link with health management data and allows a user to reduce a risk of taking an undesirable foodstuff such as a hated food or a food allergenic to the user or a religious taboo, such as meat for a vegetarian. With health consciousness, the above-mentioned functions are called for by people, who can be candidates for members of the data center, i.e., the service according to the present invention.

From the viewpoint of an eating-house, being affiliated with the data center allows the eating-house to get the lot of users as mentioned above (because the above mentioned member can be provided with the service at the affiliated eating-houses). Affiliated eating-houses can get more customers, which results in the higher income.

If eating-house data is kept in a data center, system capacity of an eating-house system can be reduced.

When eating-house data includes trade secret information and if the system is configured to make each eating-house manage the eating-house data of its own, the information can be protected against leakage to the other eating hoses.

Most foodstuffs can be an allergen. It is impossible to mark each item in a menu (food) containing an allergenic foodstuff as “warning: including harmful foodstuff”. However, a customer may have a food ordered by another customer at the same dining table. Therefore, the present invention with the group recognition means and the warning means can warn about a harmful foodstuff when a member of a dining table orders a food containing the harmful foodstuff. This can easily prevent a customer from taking an allergenic food.

If the present invention is configured to provide an item on a menu from menu information including option information by setting the option information in the menu information, an eating-house can previously put a foodstuff, which can be allergenic, as an option on an item on a menu (for a vegetarian, meat can be an option) to prevent a risk. This also allows the eating-house to exclude customer's hated food and let customers have more menu choices. Thus, the eating-house can expect to have many customers. Most extremely, some customers may evaluate such an eating-house as a “restaurant with no dislikes”. With option data provided for eating-house data, aggregating errors in calories and intakes for each nutrient can be reduced. Overs and shorts of a calorie intake and an intake of each nutrient can be adjusted by using options (increasing and decreasing foodstuffs may adjust the overs and shorts).

According to the present invention, if the system is configured to include information on an allowable intake for each of durations with different time lengths and a previous intake for a customer so as to provide the customer with the allowable intake for the current meal based on that information, a calorie intake or an intake for each nutrient can be managed in a long-term flexible way. For example, a customer can have a meal with an intake between the upper limit and the lower limit for a single meal, in a day, and for a week.

The present invention can be configured to have such entries as a calorie intake, an intake for each nutrient, besides information including likes, dislikes, and allergy in the personal data region in order to calculate an intake based on each eating-house data and aggregate intakes. In this case, health management (intake management) can be performed on the basis of health management information.

If the present invention is configured to input a customer's evaluation of the current meal for updating the customer's preference information, a recommended menu reflecting the input evaluation may be provided with the customer at the next visit.

In this case, when all the franchised eating-houses are managed as a single eating-house and if a customer has visited one of the eating-houses, the customer's evaluation of a previous meal can be checked before placing an order even at an eating-house different from one the customer visited before. Evaluation information has only been obtained by means of questionnaire. With this system, a feedback with true data can be obtained instead of a joke or a lie, because a user fundamentally gives a true answer for the next visit.

If the present invention is configured to input a customer's evaluation of the current meal for updating the customer's preference information as well as visit information including preference information from the eating-house's customer in order to retrieve target customers of the eating-house's advertisement on the basis of the visit information to the eating-house, the eating-house can avoid sending an advertisement or notice on its new item on a menu or discount information to any customer whose hated foodstuff or harmful foodstuff is contained in the item. Thus, the eating-house can send effective information to the customers who need the information. This reduces negative factors of the eating-house.

If the present invention includes a terminal through which personal data is recorded in and/or retrieved from the data center, in addition to the data center and the eating-house system, a user can use the terminal at home and reflect information on a meal taken at home in health management information, for example. In this case, the terminal can also be set at a hospital or a diet support center, actual intake of calorie or each nutrient at an eating-house and at home can be sent to the hospital or the diet support center on the basis of feedback information after the meal to get more accurate diagnosis from the hospital or the diet support center.

### BRIEF DESCRIPTION OF THE DRAWINGS

FIG. 1 is a system block diagram of an entire system illustrating an embodiment of a menu-order selection support system according the present invention;

FIG. 2 is a diagram showing an exemplary foodstuff table forming a personal data shown in FIG. 1;

FIG. 3 is a diagram showing an exemplary nutrient management (allowable intake) table forming personal data shown in FIG. 1;

FIG. 4 is a diagram showing an exemplary intake data table forming personal data shown in FIG. 1;

FIG. 5 is a diagram showing an exemplary personal feedback information table forming personal data shown in FIG. 1;

FIG. 6 is a diagram showing an exemplary personal authentication table forming personal data shown in FIG. 1;

FIG. 7 is a diagram showing an exemplary foodstuff data table forming eating-house data shown in FIG. 1;

FIG. 8 is a diagram showing an exemplary copy of feedback information forming eating-house data shown in FIG. 1;

FIG. 9 is a diagram showing an exemplary copy of user information of the eating-house forming eating-house data shown in FIG. 1;

FIG. 10 is a diagram showing an exemplary piece of order information forming eating-house data shown in FIG. 1;

FIG. 11 is a flowchart illustrating processes in the embodiment;

FIG. 12 is a diagram showing flows of data in the embodiment;

FIG. 13 is a flowchart illustrating a detailed recommended menu decision process shown at step a2 in FIG. 11;

FIG. 14 is a diagram showing an exemplary menu screen displayed on a menu terminal;

FIG. 15 is a flowchart of an allowable-values-for-the-current-meal calculating routine at step b2 in FIG. 13;

FIG. 16 is a diagram showing an allowable intake data table for illustrating an algorithm for calculating an allowable intake according to the flowchart of FIG. 15;

FIG. 17 is a diagram showing a current allowable intake calculation table for illustrating an algorithm for calculating an allowable intake according to the flowchart of FIG. 15;

FIG. 18 is a diagram showing a final intake calculation table for illustrating an algorithm for calculating an allowable intake according to the flowchart of FIG. 15;

FIG. 19 is a diagram showing an exemplary calculation of calorie assuming that a week consists of three days for simplicity;

FIG. 20 is a flowchart illustrating the same eating-house information retrieval process for feedback information performed at step b3 in FIG. 13;

FIG. 21 is a flowchart illustrating a recommended food retrieval process performed at steps b5, b8, and b11 in FIG. 13;

FIG. 22 is a flowchart of an order decision process performed at step a3 in FIG. 11;

FIG. 23 is a flowchart of a kitchen instruction and service instruction process at step a6 in FIG. 11;

FIG. 24 is a display screen of a list of foods to be prepared displayed on a kitchen terminal;

FIG. 25 is a diagram showing a service instruction screen displayed on a service terminal;

FIG. 26 a flowchart of a feedback entry process performed at step a10 in FIG. 11;

FIG. 27 is a diagram showing an exemplary feedback screen;

FIG. 28 is a flowchart of a personal data updating process performed at step all in FIG. 11;

FIG. 29 is a flowchart illustrating an eating-house's advertising processes;

FIG. 30 is a diagram showing a setting procedure of personal data to a data center;

FIG. 31 is a diagram showing an obtaining procedure of personal data by a terminal outside an eating-house system, i.e., a personal terminal or a terminal placed at a hospital or diet support center;

FIG. 32 is a diagram showing another embodiment of a menu-order selection support system according to the present invention; and

FIG. 33 is a diagram showing a procedure for the system shown in FIG. 32 where each eating-house manages eating-house data of its own.

### DETAILED DESCRIPTION OF THE PREFERRED EMBODIMENTS

Embodiments according to the present invention will be described below.

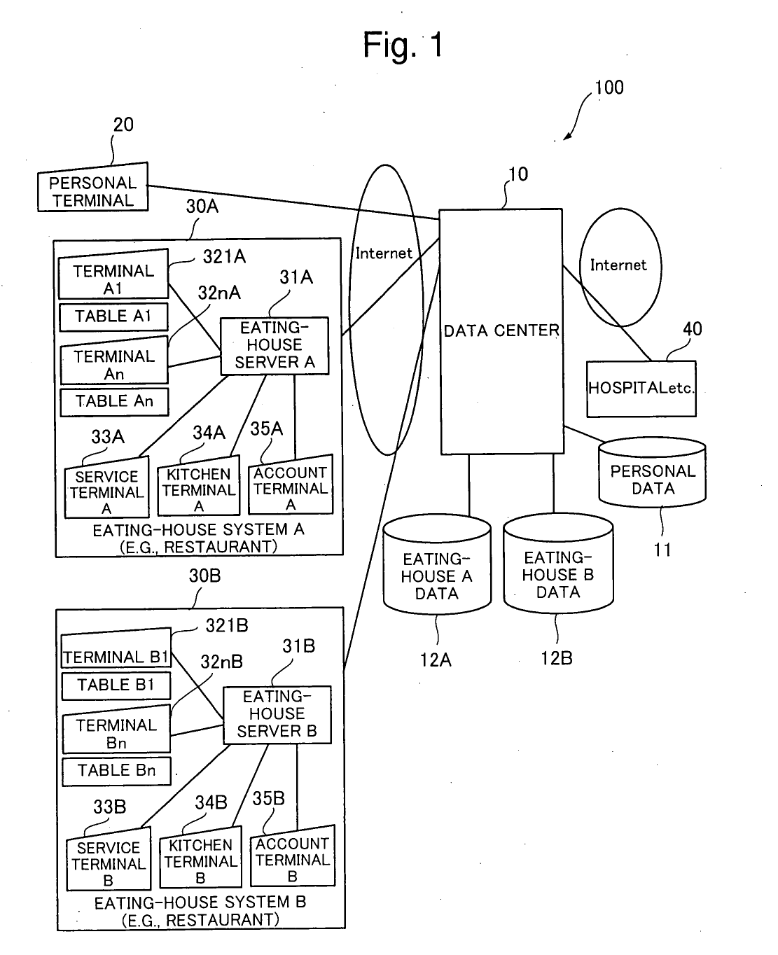

FIG. 1 is a system block diagram of an entire system illustrating an embodiment of a menu-order selection support system according the present invention.

In menu-order selection support system 100 shown in FIG. 1, data center 10, a single personal terminal 20, two eating-house systems 30A and 30B, and a single terminal set in a hospital or the like 40 (in this case, it is hospital terminal 40 set in a hospital) are shown. The personal terminal 20, eating-house systems 30A and 30B, and hospital terminal 40 are shown for an exemplary purpose only, and more number of terminals and eating-house systems are connected in general.

Data center 10, personal terminal 20, eating-house systems 30A and 30B, and hospital terminal 40 are connected via a communication line (in this example, via Internet).

At data center 10, personal data 11 and eating-house data 12A and 12B are stored and managed.

Eating-house systems 30A and 30B include eating-house servers 31A and 31B, table terminals 321A, . . . , 32nA and 321B, . . . , 32nB associated with the respective tables, service terminals 33A and 33B, kitchen terminals 34A and 34B, and accounting terminals 35A and 35B, respectively.

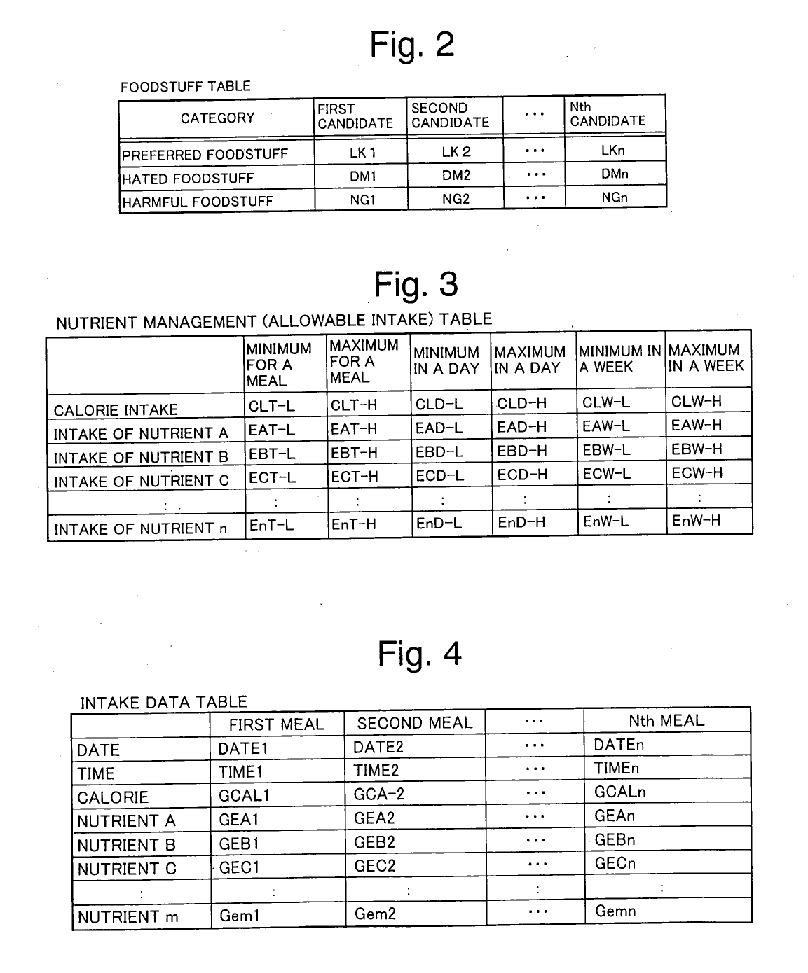

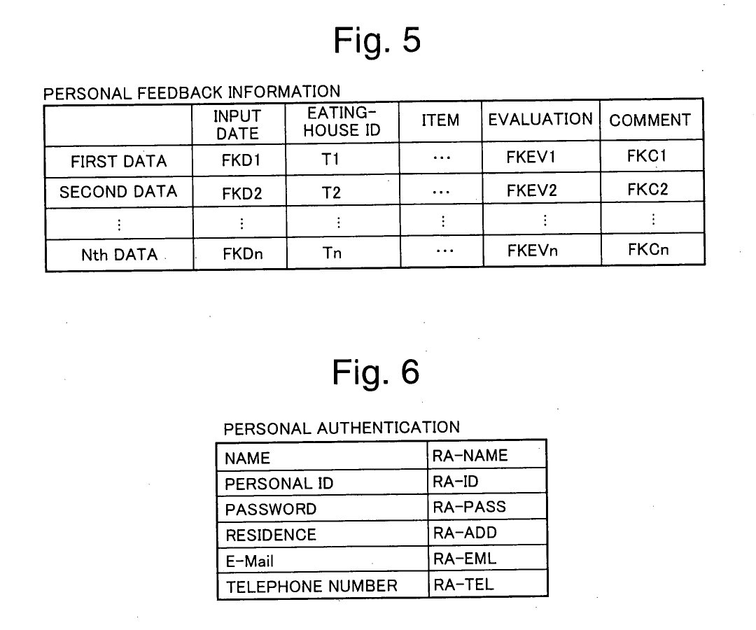

FIGS. 2 to 6 exemplify various tables forming personal data 11 shown in FIG. 1. FIG. 2 is a foodstuff table; FIG. 3 is a nutrient management table; FIG. 4 is an intake data table; FIG. 5 is a personal feedback information table; and FIG. 6 is a personal authentication table. Among these tables forming personal data, the combination of a foodstuff table shown in FIG. 2 and a personal feedback table shown in FIG. 5 corresponds to preference information in the present invention, information on harmful foodstuffs in the foodstuff table shown in FIG. 2 corresponds to harmful foodstuff information, and the combination of a nutrient management (allowable intake) table shown in FIG. 3 and an intake data table shown in FIG. 4 corresponds to health management information in the present invention.

In a foodstuff table shown in FIG. 2, a person's preferred foodstuff, hated foodstuff, harmful foodstuff prohibited for allergy or religious reason are recorded.

In a nutrient management (allowable intake) table shown in FIG. 3, the minimum acceptable intake for a meal (the minimum intake per meal), the maximum allowable intake for a meal (the maximum intake per meal), the minimum acceptable intake in a day (the minimum intake per day), the maximum allowable intake in a day (the maximum intake per day), the minimum acceptable intake in a week (the minimum intake per week), and the maximum allowable intake in a week (the maximum intake per week) regarding calorie and nutrients A, B, . . . , n for a person are recorded.

Although the minimum intake and the maximum intake for a meal, in a day, and in a week are recorded and an intake is managed on the basis of them in this embodiment, an intake for other durations, for example, for a month may also be recorded for intake management.

In an intake data table shown in FIG. 4, the person's intake calorie and an intake of each nutrient are recorded for each meal.

In a personal feedback information table shown in FIG. 5, the person's evaluation of a meal at each eating-house is entered. All the franchised eating-houses have the same eating-house identification data. A recommended menu is provided at any of the franchised eating-houses by referencing the history of the person.

A personal authentication table shown in FIG. 6 is a table recording data identifying a person. Personal authentication is performed on the basis of this data when data center 10 shown in FIG. 1 is accessed.

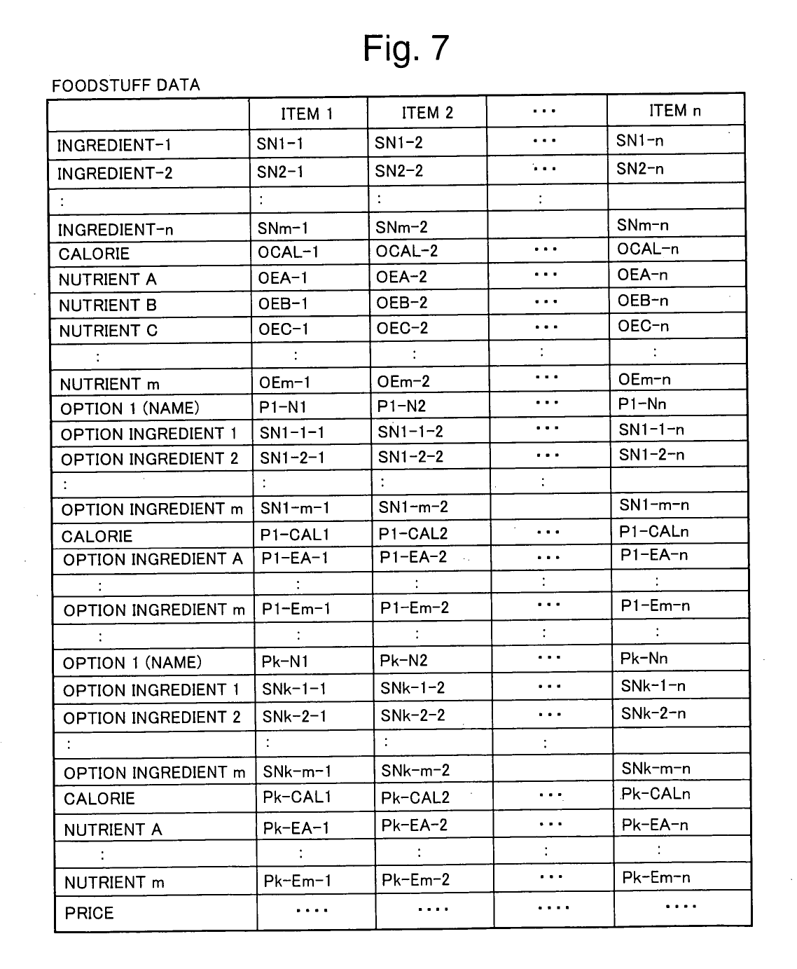

FIGS. 7 to 10 exemplify eating-house data 12A shown in FIG. 1 (eating-house data 12B also has the same configuration).

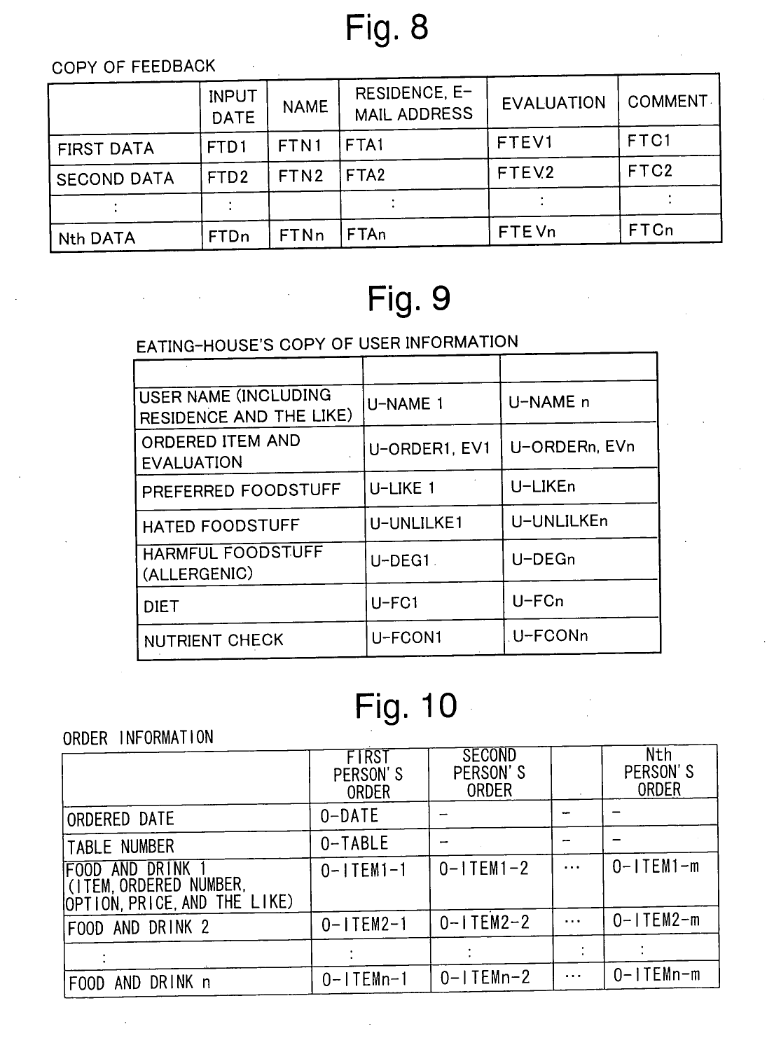

FIG. 7 is a table showing ingredients, calories and contents of each nutrient, optional information (substitute foodstuff, a calorie and a content of each nutrient for the substitute foodstuff), and price for each item on a menu provided at the eating-house. FIG. 8 is a copy of feedback information on a customer's evaluation of a meal at the eating-house and the like. FIG. 9 is a copy of information on the eating-house's customer. FIG. 10 is order information recording orders from customers visited the eating-house.

Each person (user) and each eating-house to use this system perform preparation as shown below before using this system.

User's Side

Record allergy information or food information including likes and dislikes in data center 10 via Personal Computer (PC) (personal terminal 20 or hospital terminal 40 shown in FIG. 1) or the like.

If desired, also register calorie and element (nutrient) information allowable to take for a day as well (as an option for health management, weight-controlling diet, or therapeutic diet such as for diabetes).

This information is managed by personal ID and a password.
(a) personal information: name, ID, password, residence, Email address, telephone number, and so on.
(b) likes
(c) dislikes
(d) harmful foodstuff (allergic foodstuff or such item as meat for a vegetarian)
(e) allowable calorie intake for a meal/a day/a week (the minimum and the maximum): option
(f) allowable intake for each nutrient for a meal/a day/a week (the minimum and the maximum): option

Food information (calorie and intake of each nutrient) on a meal taken at home can also be registered.

The information is recorded in each table (FIGS. 2, 3, 6) forming personal data 11 shown in FIG. 1.

Eating-House Side

Input information such as ingredients or elements (nutrient) used and their calorie for each item on a menu in a form as a data center requests (have to be updated when desired).

The information is recorded in a foodstuff data table (see FIG. 7) forming eating-house data 12A and 12B shown in FIG. 1. The eating-house data is kept in data center 10 in the embodiment.

Set a unique number (a unique number for a dining table) for each menu display terminal at each dining table. If a person's belonging (PC or PDA) is used as a menu terminal, the data can be processed via web in HTML. The terminal may be specific to an eating-house. If the terminal is an eating-house terminal, the number for each dining table may be registered in advance. If a personal terminal is used as a menu terminal, a dining table number has to be entered, for example, manually, or by a system uniquely decides a dining table number via a nearest wireless port.

When a User Visits an Eating-House

An ordering person takes a seat, inputs his/her ID and a password (they can be substituted by a credit card) at a menu terminal. An eating-house system of the eating-house obtains personal data and the eating-house data from data center 10. A menu with items excluding a problematic foodstuff (a harmful foodstuff and a hated foodstuff) and a recommended menu (an item with many of the user's preference, an item favorably evaluated by the user at the previous visits, an item with an option to exclude a hated foodstuff, an item with an option to balance a calorie or an intake of each nutrient for a day/a week by increasing or decreasing foodstuffs) are displayed according to the eating-house data of the eating-house.

The user places an order looking at the recommended menu.

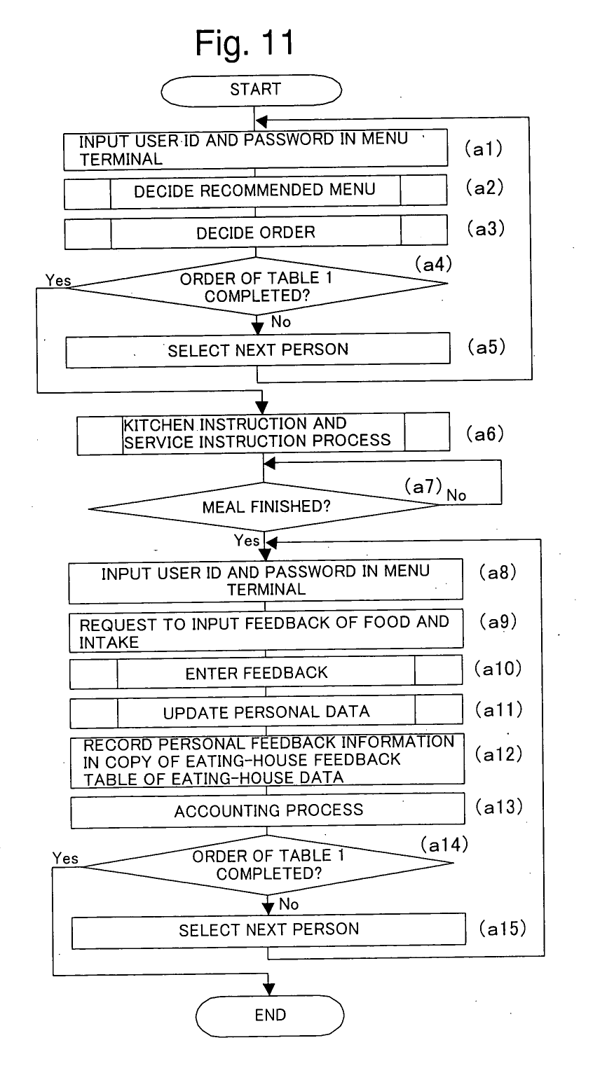

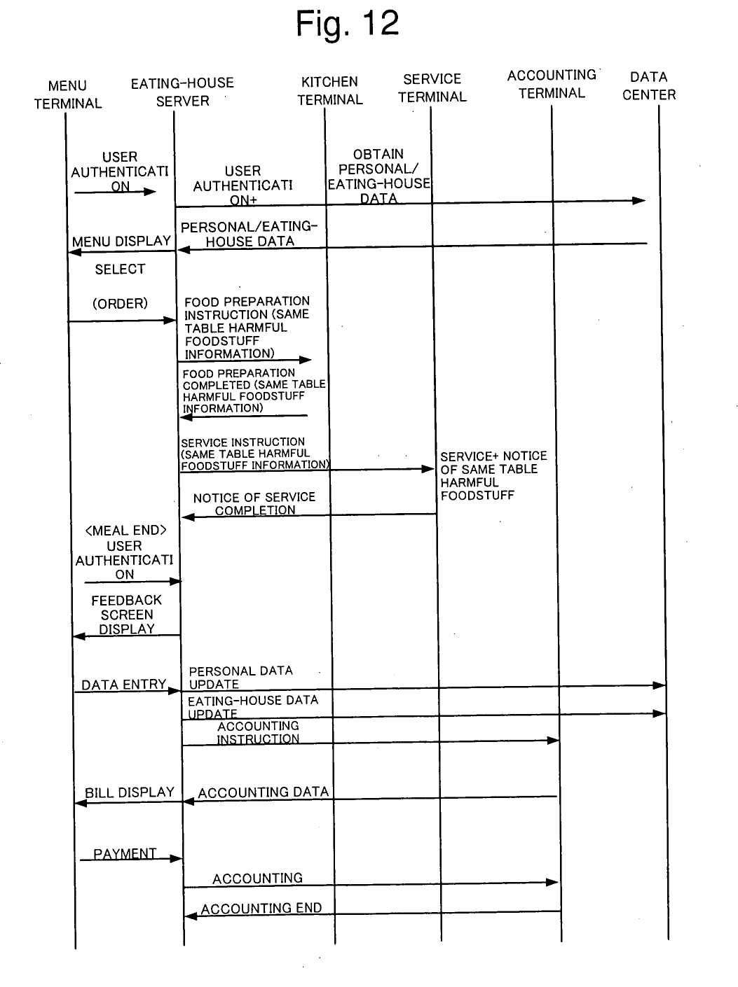

FIG. 11 is a flowchart illustrating processes in the embodiment. FIG. 12 is a diagram showing a flow of data in the embodiment.

First, a customer visited the eating-house inputs a user ID and a password from a menu terminal (e.g., menu terminal 21A shown in FIG. 1) set at the dining table that the customer takes a seat (FIG. 11, step a1). The user ID and password are sent from the menu terminal to the eating-house server of the eating-house (e.g., terminal 31A shown in FIG. 1.). The user ID and password are further sent to data center 10 shown in FIG. 1 via Internet from the eating-house sever for an authentication (see personal authentication table shown in FIG. 6). The eating-house server requests the data center to send the customer's personal data (FIGS. 2 to 6) and the eating-house data of its own (FIGS. 7 to 10). In response to the request, the data center sends the requested personal data and the eating-house data to the requesting eating-house server. The eating-house server decides a recommended menu matching the data on the basis of the personal data and the eating-house data received from the data center and sends the menu to the menu terminal (FIG. 11, step a2). The recommended menu is displayed on the menu terminal. Details of the decision of a recommended menu will be described later.

Next, an order based on the recommended menu is input from the menu terminal (FIG. 11, step a3).

If persons are sitting at the same dining table, the same processes (steps a1 to a4) are repeated for all of the customers in turn (see FIG. 11, steps a4, a5, FIG. 10). The input orders are sent from the menu terminal to the eating-house server.

When all the customers have ordered, the operation continues to a kitchen indication and service instruction process (step a6). That is to say, the eating-house server first instructs the kitchen terminal (e.g., kitchen terminal 34A shown in FIG. 1) to prepare the ordered foods. If an ordered food contains a harmful foodstuff for a customer at the dining table, information indicating that a harmful foodstuff is contained is also sent to the kitchen terminal, which displays the ordered foods and harmful foodstuff information. When a food is prepared, a kitchen staff inputs to indicate that the food has been prepared on the kitchen terminal. The kitchen terminal is preferably configured to cause a kitchen stuffer to input that the stuffer is aware that the food contains the harmful ingredient when the staff makes the food containing the harmful foodstuff.

Such information indicating that the food is prepared is sent from the kitchen terminal to the eating-house server. In response to the information, the eating-house server instructs the service terminal to service the food. When a food contains a harmful foodstuff for a member of a dining table, the service terminal is also indicated as such thereon. The service terminal instructs a service staff to service the food. When the food contains a harmful foodstuff for a customer at the dining table, warning is made. A service staff calls attention of customers that the harmful foodstuff to a customer at the dining table is contained in the food when the food contains that foodstuff, and inputs into the service terminal that the food is served. The service terminal can be configured to cause a kitchen stuffer to input for confirming the stuffer has called attention of the customers that the harmful foodstuff is contained in the food, when the harmful foodstuff is contained in the food.

When customers finish the meal (step a7), the customers input each user ID and password from the menu terminal again (step a8) and input feedback information indicating the customer's evaluation of the meal and whether the customer ate everything on the dishes or not. In response to the input, the eating-house server instructs the menu terminal to display a feedback screen for the customers to input feedback information, asks the customers to input feedback information (step a9). When the feedback information is input (step a10), the input feedback information is sent from the eating-house server to the data center, where the customer's personal data managed is updated (FIG. 11, step all). Then Copy of Eating-House Feedback Table (see FIG. 8) forming the eating-house data of the eating-house (e.g., eating-house data 12A shown in FIG. 1) is updated (step a12). If the customer is new to the eating-house, or the customer has new information, Copy of the User Information (see FIG. 9) forming the eating-house data of the eating-house is also updated.

Then, accounting for the meal is performed (step a13). An accounting instruction is issued from the eating-house server to the accounting terminal. In response, an accounting staff inputs various kinds of data necessary to accounting, for example, whether the customer has a discount ticket or not. The accounting data is sent to the eating-house server, where the bill (the amount is calculated) is added up on the basis of the accounting data and the amount is sent to the menu terminal. The menu terminal displays the amount. When the customer inputs to indicate that the customer agrees to pay the bill (the amount of the account) on the menu terminal, the eating-house server issues an instruction to the accounting terminal to settle the account. When an accounting staff inputs to indicate that the account is settled on the accounting terminal, the eating-house server is informed that the account is settled.

If two or more customers are taking seat at the same dining table, the processes after the meal (FIG. 11, steps a14, a15) are repeated for each of the customers in turn.

Processes in the embodiment have been outlined above. Each of the processes will be further detailed below.

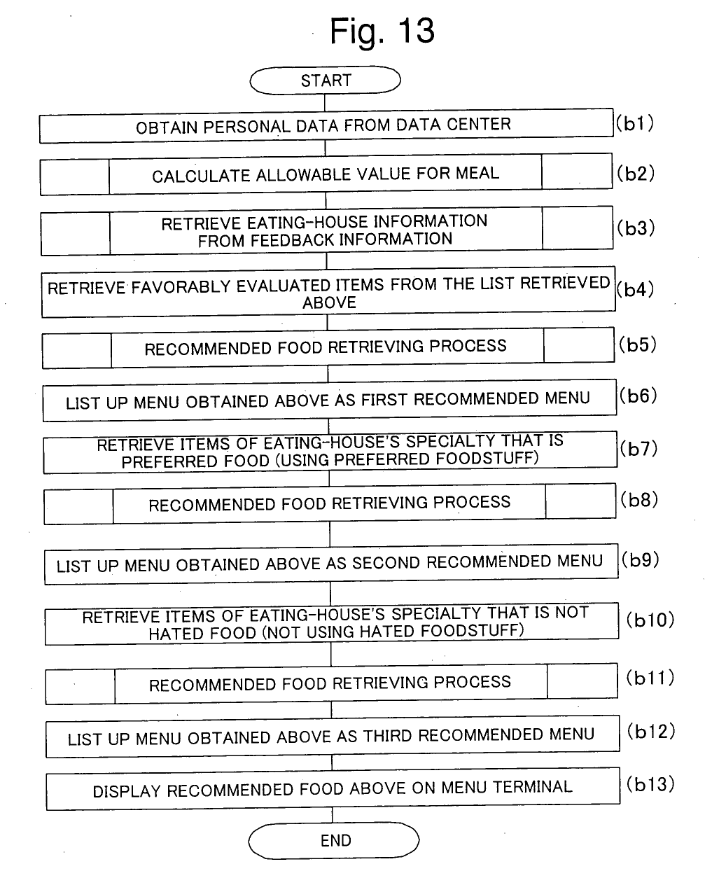

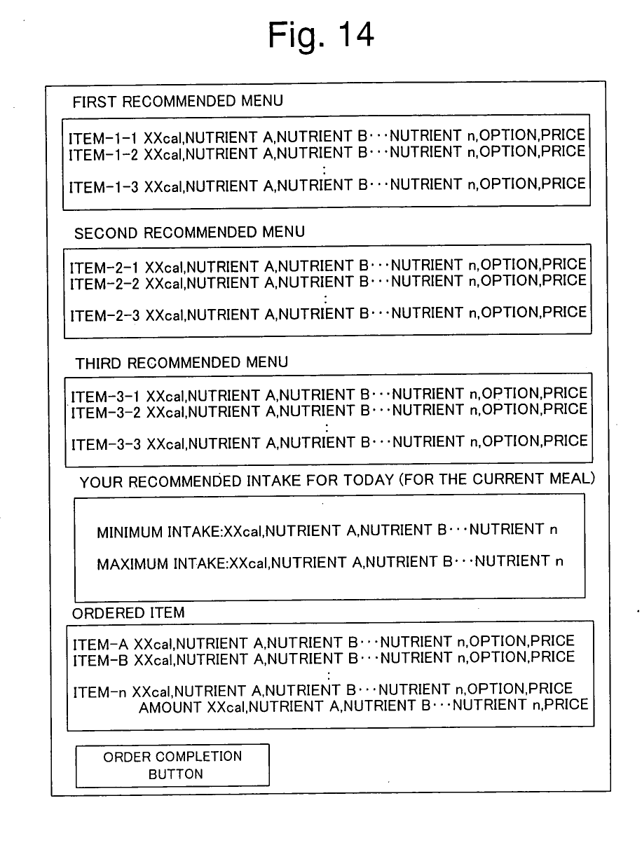

FIG. 13 is a flowchart illustrating details of a recommended menu decision process shown at step a2 in FIG. 12. FIG. 14 is a diagram showing an exemplary menu screen displayed on a menu terminal.

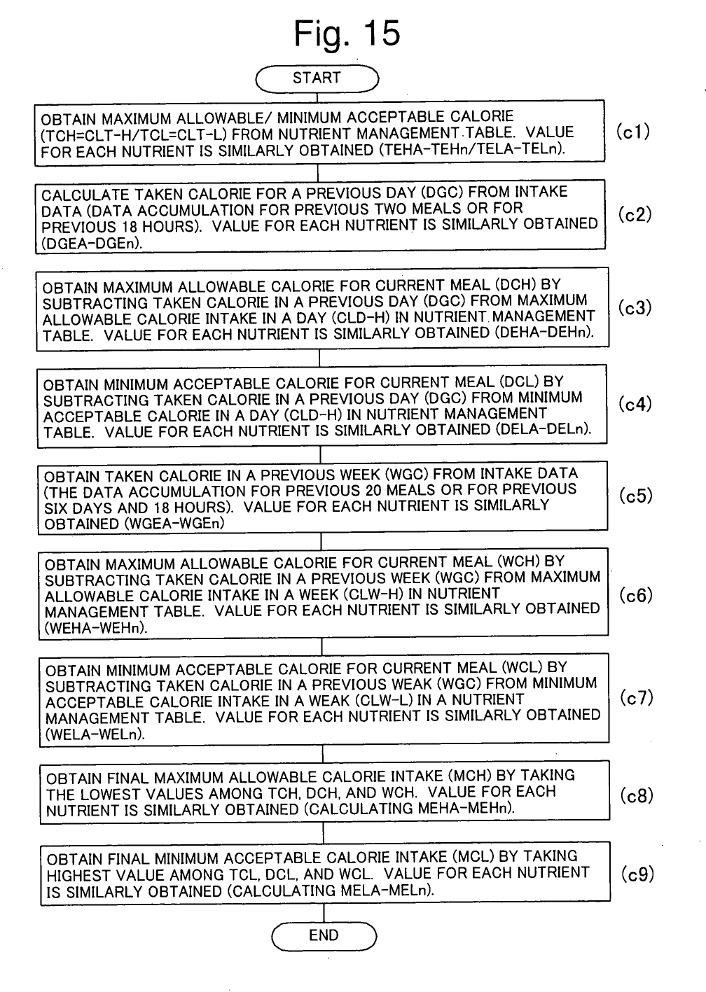

First, personal data on the customer is obtained from the data center (step b1), and allowed calorie and an allowable intake of each nutrient are calculated for the customer's current meal (step b2, see the field “your recommended intake for today (for current meal)” in FIG. 14). The processing of calculation of the allowable intake will be further described later (see FIGS. 15-18).

Then, the eating-house's information is retrieved from feedback information (see FIG. 11, steps a9, a10 and FIG. 5) previously input by the customer (step b3, described later in detail). Favorably evaluated items are retrieved from the retrieved list (step b4). Recommended items are further retrieved from the retrieved favorably evaluated menus, which is a recommended food retrieval process (step b5, described later in detail). The recommended items resulted from the recommended food retrieval process are listed up as the first recommended items (step b6, see “first recommended menu” in FIG. 14).

Next, items that are specialties of the eating-house (foods listed up in foodstuff data table in FIG. 7) and contain the customer's preferred foodstuffs (foodstuffs on a foodstuff table listed as preferred foodstuffs in FIG. 2) are retrieved (step b7). A recommended food retrieval process is performed again (step b8) and the items obtained from the process are listed up as the second recommended items (step b9, see “second recommended menu” at FIG. 14). Then, foods that are specialties of the eating-house (foods listed up in foodstuff data table in FIG. 7) and does not contain the customer's hated foodstuff (foodstuffs on foodstuff table listed as hated foodstuff in FIG. 2) are retrieved (step b10). A recommended food retrieval process is performed again (step b11) and items obtained from the process are listed up as the third recommended items (step b12, see the field “third recommended menu” in FIG. 14). Allowable intakes for a calorie and each nutrient for thus obtained meal (step b2) and the listed first to the third recommended items (step b6, b9, b12) are displayed on the menu terminal (step b13).

At this stage, “first recommended menu”, “second recommended menu”, “third recommended menu”, and “your recommended intake for today (for the current meal)” are displayed in the screen shown in FIG. 14.

In a field of each recommended menu, a name of the food (e.g., “item 1-1”), and the food's calorie, a content of each of the nutrients A, B, . . . , n, and if the option is selected, the option information, and price are displayed.

In a field of “your recommended intake for today (for the current meal)”, the minimum acceptable calorie and the minimum acceptable intake for each of the nutrients A, B, . . . , n that should be taken for this meal and the maximum allowable calorie and the maximum allowable intake for each of the nutrients A, B, . . . , n that should not be exceeded are displayed.

A display screen of the menu terminal is in the form of a touch panel. When a user touches a name of the recommended foods displayed on the menu screen shown in FIG. 14, the data on the food touched by the user is also displayed in the field “ordered item”. When a user touches data on a food displayed in the field “ordered item”, the touched food is deleted form the field “ordered item”. Finally, when a user touches “order completion button”, foods currently listed up in the field “ordered item” are ordered.

If the sum of calories and intakes of each of nutrients A, B, . . . , n of all the listed items in the field “ordered item” is not enough yet, the minimum acceptable calorie and an intake for each of nutrients A, B, . . . , n flickers on the field “your recommended intake for today (for the current meal)”, indicating the value is not enough. Similarly, if the maximum allowable intake is exceeded, that exceeding item flickers, indicating that the value is exceeding. Therefore, at the stage when the field of ordered item is blank, all the entries in a line of the minimum intake are flickering, and the customer selects a food to order in order to change the flickering items into lighted items.

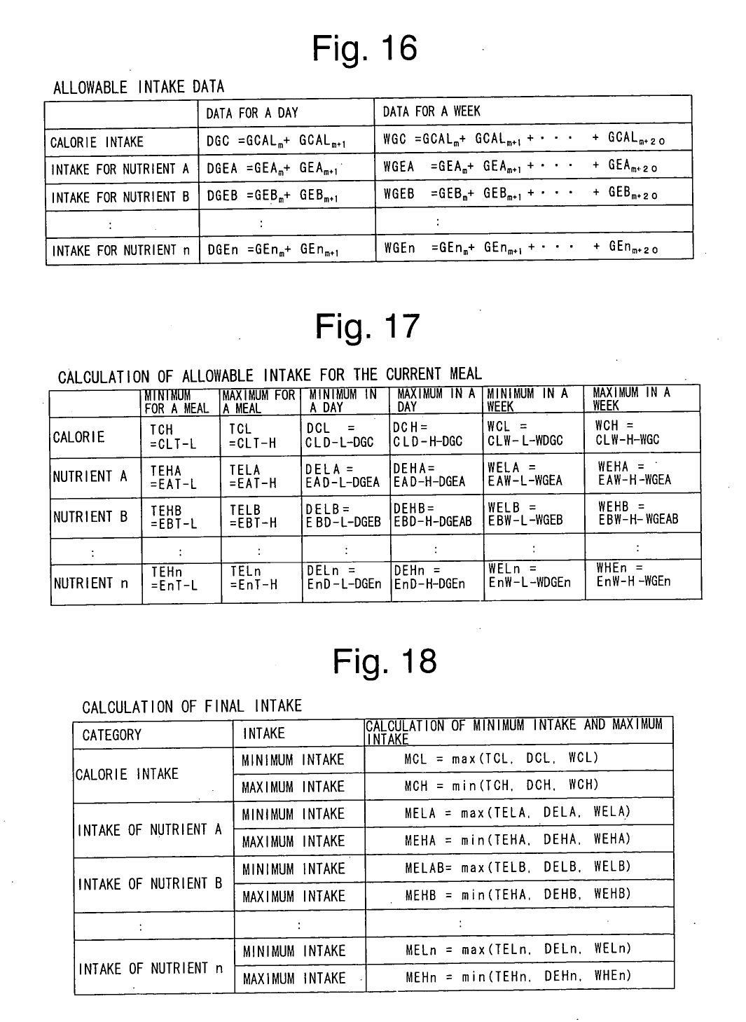

FIG. 15 is a flowchart of an allowable-values-for-meal calculating routine at step b2 in FIG. 13. FIGS. 16-18 are respective tables illustrating an algorithm for calculating an allowable intake according to the flowchart in FIG. 15.

FIG. 16 is a table showing calculation algorithm for calculating previous calorie and an intake of each nutrient for a day and for a week. FIG. 17 is a table showing calculation algorithm for calculating an allowable intake for the current meal. FIG. 18 is a table showing calculation algorithm for calculating the minimum intake and the maximum intake for the current meal. The calculation algorithms will be described later primarily for calorie with reference to FIG. 15. Calculation algorithms for nutrients are similar to those for calorie.

First, each person shown in FIG. 3 or a hospital or the like in place of each person obtains the maximum allowable/the minimum acceptable calorie (TCH=CLT-H/TCL=CLT-L) from a nutrient management table for the person. The value for each nutrient is similarly obtained (TEHA-TEHn/TELA-TELn) (step c1). Based on this value, each value of “minimum for a meal” and “maximum for a meal” shown in FIG. 17 is also obtained. Then, taken calorie for a previous day (DGC) is calculated from the intake data table in FIG. 4 (data accumulation for previous two meals or for previous 18 hours) and the value is obtained. The value for each nutrient is similarly obtained (DGEA-DGEn) (step c2). A value of “data in a day” in allowable intake data shown in FIG. 16 is thus obtained.

Next, the maximum allowable calorie in a day for the current meal (DCH) is obtained by subtracting the taken calorie in a previous day (DGC) from the maximum allowable calorie intake in a day (CLD-H) in a nutrient management table (FIG. 3). The value for each nutrient is similarly obtained (DEHA-DEHn) (step c3). The minimum acceptable calorie for the current meal (DCL) is obtained by subtracting the taken calorie in a previous day (DGC) from the minimum acceptable calorie in a day (CLD-L) in the nutrient management table. The value for each nutrient is similarly obtained (DELA-DELn) (step c4). Each value of “the minimum in a day” and “the maximum in a day” shown in FIG. 17 is thus obtained.

Taken calorie in a previous week (WGC) is obtained from the intake data table shown in FIG. 4 (the data accumulation for previous 20 meals or for previous six days and 18 hours) and the value is obtained. The value for each nutrient is similarly obtained (WGEA-WGEn) (step c5). A value of “data for a week” shown in FIG. 16 is thus obtained.

The maximum allowable calorie for the current meal (WCH) is obtained by subtracting the taken calorie in a previous week (WGC) from the maximum allowable calorie intake in a week (CLW-H) in the nutrient management table (FIG. 3). The value for each nutrient is similarly obtained (WEHA-WEHn) (step c6). The minimum acceptable calorie for the current meal (WCL) is obtained by subtracting the taken calorie in a previous week (WGC) from the minimum acceptable calorie intake in a week in the nutrient management table (CLW-L) The value for each nutrient is similarly obtained (WELA-WELn) (step c7) The steps c6 and c7 give “the minimum in a week” and “the maximum in a week” shown in FIG. 17.

The maximum allowable calorie intake (MCH) shown in FIG. 18, which is the goal, is obtained by taking the lowest values among the TCH, DCH, and WCH. The value for each nutrient is similarly obtained (calculating MEHA-MEHn) (step c8). The minimum acceptable calorie intake (MCL), which is the goal, is obtained by selecting the highest value among the TCL, DCL, and WCL. The value for each nutrient is similarly obtained (calculating MELA-MELn) (step c9). Steps c8 and c9 give the minimum and maximum intake for calorie and each nutrient shown in FIG. 18. Thus obtained minimum intake and maximum intake for a calorie and each nutrient are displayed in the field “your recommended intake for today (for the current meal)” in a menu screen shown in FIG. 14.

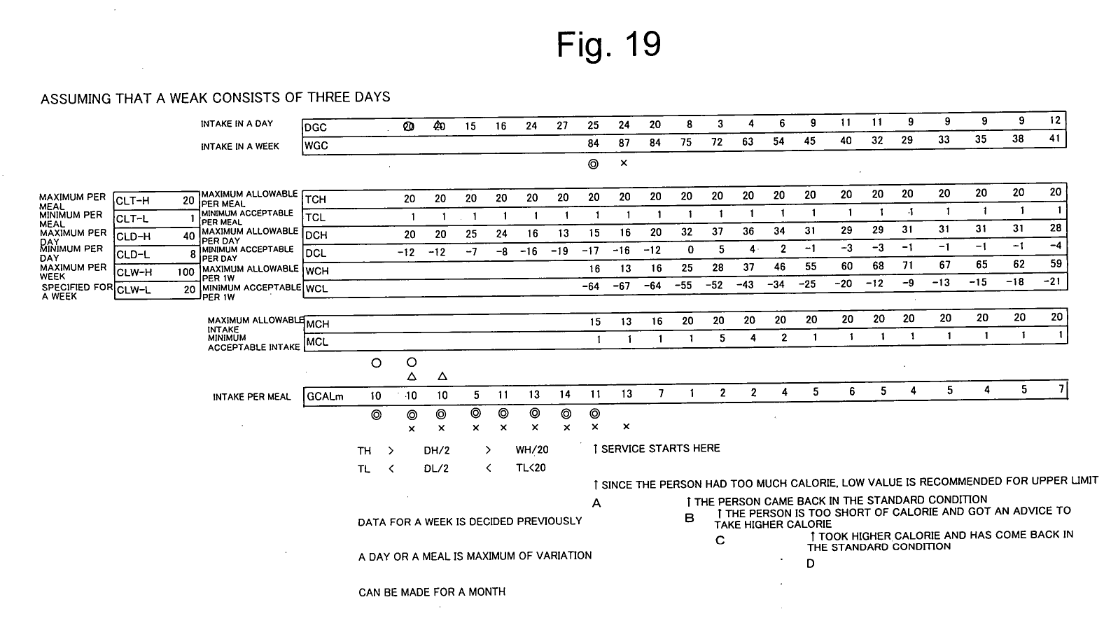

FIG. 19 shows an exemplary calculation for calorie assuming that a week consists of three days for simplicity.

As shown in the last line in FIG. 19, an intake calorie for each meal GCALm is assumed to be 10, 10, 10, 5, 11, 13, 14, 11, 13, 7, . . . .

Each of intakes in a day DGC 20, 20, 15, . . . shown in the top line in FIG. 19 is obtained from an intake for each meal GCALm in the manner shown below. DGC is obtained from the sum of taken calorie for previous two meals (the current meal is excluded). 10 and 10, both are marked with ; in the line of intake GCALm for each meal, make 20, which is marked with ; in the line of the taken calorie for a day DGC, while 10 and 10, both are marked with < in the line of intake GCALm for each meal, make 20, which is marked with < in the line of the taken calorie for a day DGC. Each value in the line of the taken calorie for a day DGC is similarly obtained.

Assuming that a week consists of three days (nine meals) here, the intake for 1 W (a week) shown in the second line in FIG. 19 is obtained from the sum of taken calorie for previous eight meals (the current meal is excluded). That is to say, the sum of 10, 10, 10, 5, 11, 13, 14, 11, which are marked with T in the line of the calorie intake for each meal GCALm, is 84, which is marked with T in the line of 1 W intake WGC. The sum of 10, 10, 5, 11, 13, 14, 11, 13, which are marked with xin the line of calorie intake for each meal GCALm, is 87, which is marked with xin the line of 1 W intake WGC. Each value in the line of 1 W intake WGC is similarly obtained.

Now, a meal marked with A will be described.

As it is shown in a table in the left of FIG. 19, it is assumed that the maximum calorie intake for a meal CLT-H is 20, the minimum calorie intake for a meal is 1, the maximum calorie intake and the minimum calorie intake in a day, CLD-H and CLD-L, are 40 and 8 respectively, and the maximum calorie intake and the minimum calorie intake in 1 W, CLW-H and CLW-L, are 100 and 20 respectively.

At the meal marked with A, the maximum allowable value for a meal TCH and the minimum acceptable value for a meal TCL are equal to the maximum for a meal CLT-H, i.e., 20, and the minimum for a meal CLT-L, i.e., 1, respectively. The maximum allowable value in a day DCH is obtained by subtracting the intake for the day DGC=25 (a calorie intake for the last two meals) from the maximum in a day CLD-H=40. Thus, DCH=15. The minimum acceptable value in a day DCL is obtained by subtracting the intake for the day DGC=25 (a calorie intake for the last two meals) from the minimum in a day CLD-L=8. Thus, DCL=−17. In the same manner, the maximum allowable value for a week WCH and the minimum acceptable value for a week WCL are obtained by subtracting the calorie intake for the week WGC=84 (a calorie intake for the last eight meals) from the maximum in 1 W, CLW-H=100 and the minimum in 1 W, CLW-L=20, respectively. Thus, WCH=16 and WCL=−64.

The finally obtained maximum allowable intake MCH is the lowest of the maximum allowable value for a meal TCH=20, the maximum allowable value in a day DCH=15, and the maximum allowable value in a week WCH=16. Thus, MCH=15. In the same manner, the finally obtained minimum acceptable intake MCL is the highest of the minimum acceptable value for a meal TCL=1, the minimum acceptable value in a day DCL=−17, and the minimum acceptable value in a week WCL-64. Thus, MCL=1.

In FIG. 19, this system started the service at meal A. Since the person has had too much calorie, a low value is recommended for the upper limit of the allowable intake MCH. At meal B, the person is in the standard condition. At meal C, the person has taken too little calorie and been advised to take higher calorie. At meal D, the person is in the standard condition again.

Since the upper limit and the lower limit for an intake is provided for durations with different time lengths in the embodiment, overs and shorts for meals can be adjusted in a relatively long span.

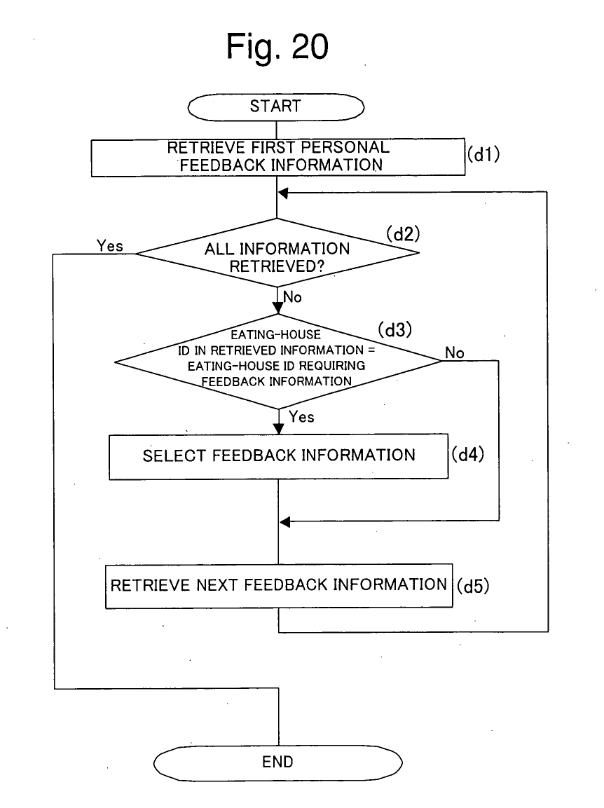

FIG. 20 is a flowchart illustrating the process of retrieving eating-house information from feedback information at step b3 in FIG. 13.

In the beginning, first personal feedback information is retrieved from a personal feedback table shown in FIG. 5 (step d1). Determination is made whether all information has been retrieved (step d2). If the result is NO, that is, new information has been retrieved, it is determined whether the eating-house ID in the new information matches ID of the eating-house that currently needs feedback information (step d3). If they match, the retrieved new feedback information is selected for recommended menu retrieval (step d4). Then, the next feedback information is retrieved from a personal feedback information table in FIG. 5 (step d5), and the operation returns to step d2.

When it is determined that all the feedback information for the customer has been retrieved at step d2, the process in FIG. 20 ends. Then the operation proceeds to a recommended food retrieval process at step b5 in FIG. 13.

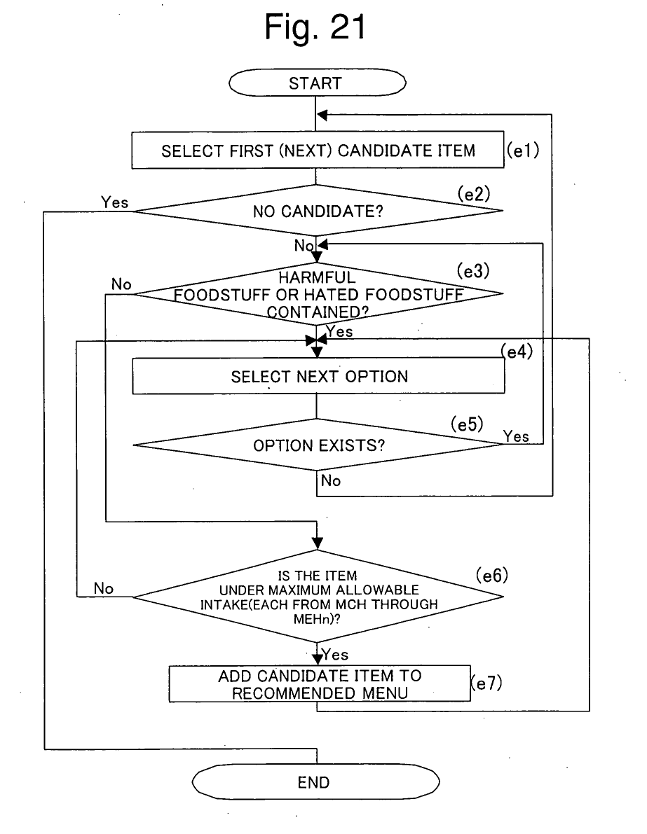

FIG. 21 is a flowchart illustrating the recommended food retrieval process performed at steps b5, b8, and b11 in FIG. 13.

First, a candidate item is selected with reference to the foodstuff data table shown in FIG. 7 (step e1). If there is no item in the table to be selected as a candidate (step e2), the process in FIG. 21 ends. If any item is remaining to be selected, the operation proceeds to step e3 and determination is made whether the candidate item selected at step e1 contains either a harmful foodstuff or a hated foodstuff (see FIG. 2) or not (step e3). If the candidate item contains either a harmful foodstuff or a hated foodstuff, the next option for that foodstuff is selected (step e4, and see FIG. 7). If any option exists at step e5, the process goes back to step e3 and determination is made whether the option is either a harmful foodstuff or a hated foodstuff.

When an item containing neither harmful foodstuff nor hated foodstuff is found as a candidate in this way, determination is made whether the found item contains values equal to or less than the maximum allowable intakes (MCH-MEHn; see the maximum intake in FIG. 18) or not (step e6). If the item contains values equal to or less than the maximum allowable intakes, the found item is added to a recommended menu (step e7).

The above process is performed on all the candidate items here (step e2).

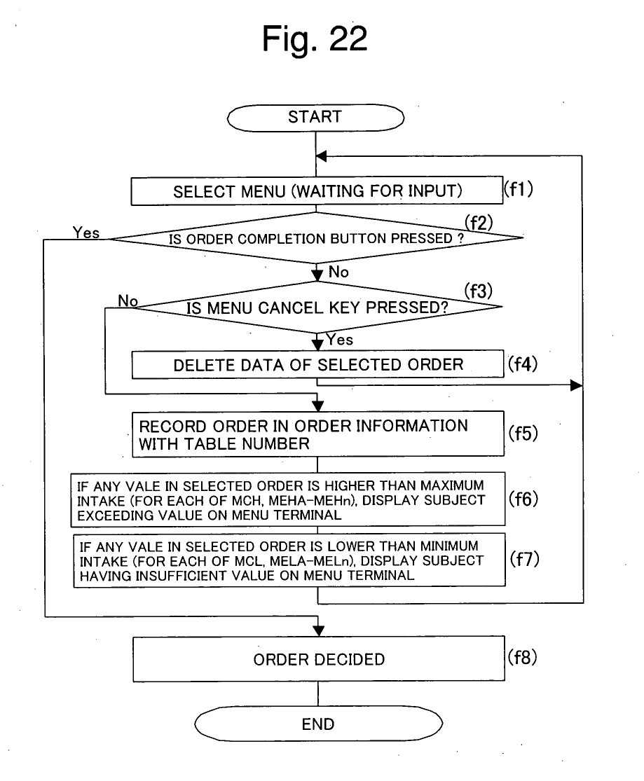

FIG. 22 is a flowchart of an order decision process performed at step a3 in FIG. 11.

A recommended menu shown in FIG. 14 is displayed on a menu terminal at step a2 in FIG. 11. As an order has not been made yet here, a calorie and an intake for each nutrient are appearing as insufficient.

The system is waiting for an input from a keyboard (for a touch panel, an input with a finger touch on the panel) (step f1). Any key-pressing causes the operation to proceed to step f2. At step f2, determination is made whether the currently pressed key is the order completion button or not. If the order completion button is pressed, the menu displayed in the field “ordered item” on the menu screen shown in FIG. 14 is decided as the order (step f8). If it is determined that the pressed key is other than the order completion button at step f2, the operation proceeds to step f3, where determination is made whether the currently pressed key is the menu cancel key not shown (for any of the items displayed in the field “ordered item” shown in FIG. 14) or not. If the currently pressed key is the menu cancel key, the data on the indicated order is deleted from order information (see FIG. 10) and the canceled menu is removed from the field “ordered item” shown in FIG. 14 (step f4).

If the currently pressed key is neither the order completion button nor the menu cancel key, any item in the field of recommended item shown in FIG. 14 has been selected for an order. The item is recorded as an order in the order information (see FIG. 10) along with a table number (step f5). If the sum of calories or the sum of intakes for each nutrient of the selected order is higher than the maximum intake (for each of MCH, MEHA-MEHn), that item flickers on the menu terminal (step f6).

If the selected order includes values lower than the minimum intake (for each of MCL, MELA-MELn), a subject having an exceeding value flickers on the menu terminal (step f7)

Each order is decided in this way.

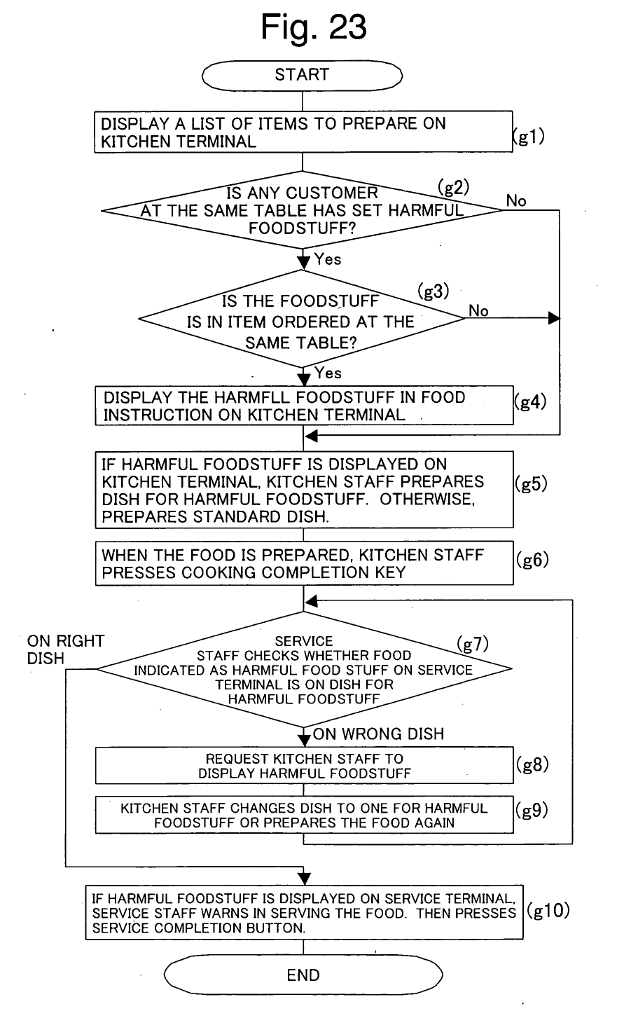

FIG. 23 is a flowchart of a kitchen instruction/service instruction process at step a6 in FIG. 11. For better understanding, FIG. 23 includes tasks of staffs in the eating-house (steps g5-g10) along with process steps performed by the system according to the embodiment.

When the ordering has thus completed, a kitchen instruction/service instruction process at step a6 in FIG. 11 starts. In this example, a list of items to be prepared is displayed on a kitchen terminal first (step g1).

If any customer at the same dining table has recorded a harmful foodstuff (step g2) and an ordered item contains the harmful foodstuff (step g3), the kitchen terminal indicates that a harmful foodstuff is contained (step g4)

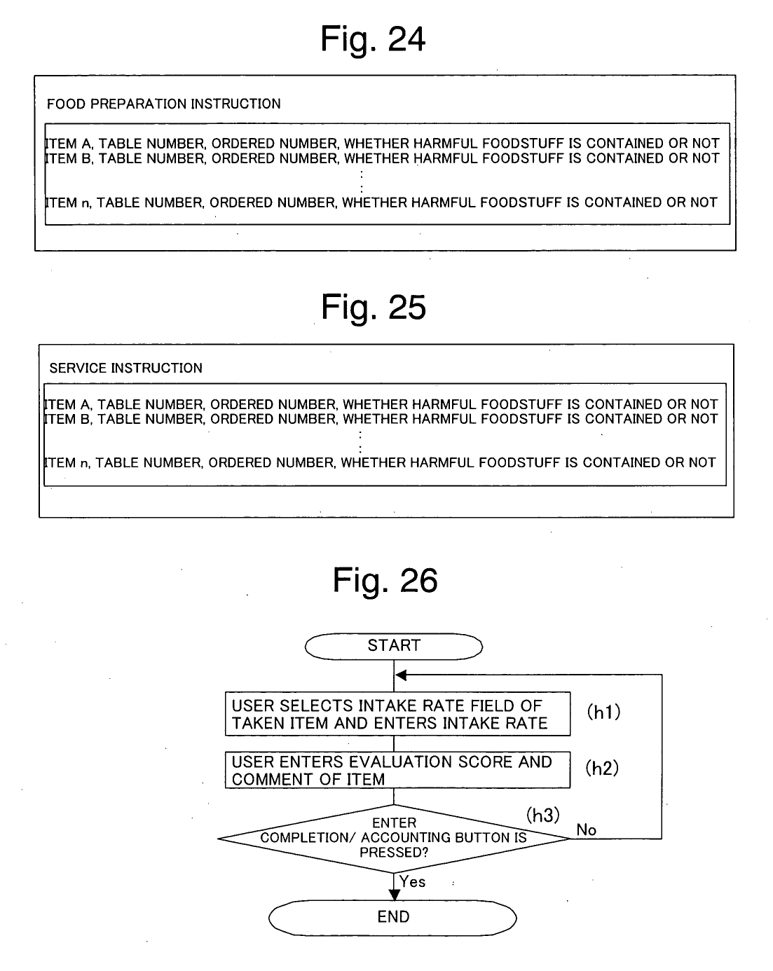

FIG. 24 is a display screen of a list of items to be prepared. This is displayed on the kitchen terminal.

On this screen, sets of an item, a table number, an ordered number, whether any harmful foodstuff is contained or not are listed.

Referring to FIG. 23 again and the process will be described.

A kitchen staff prepares a dish for harmful foodstuffs and arranges the food on it, if the kitchen terminal displays that a harmful foodstuff is contained. Otherwise, the staff prepares a standard dish and arranges the food on it (step g5). When the kitchen staff has arranged the food on the dish, the staff presses the cooking completion key on the kitchen terminal (step g6). In this example, a display screen on the kitchen terminal is a touch panel. An indication that the food has been completed is entered by a finger touch on an item that has been completed on the food preparation instruction screen shown in FIG. 24. This indication that the food has prepared is informed to a service terminal via an eating-house server as shown in FIG. 12.

FIG. 25 is a diagram showing a service instruction screen displayed on a service terminal.

On this screen, sets of prepared food items, a table number, an ordered number, and whether any harmful foodstuff is contained or not are listed. A service staff checks if the food, which is indicated to contain a harmful foodstuff on a service terminal, is arranged on a dish for harmful foodstuffs (step g7). If the food is not on the right dish, the service staff requests the kitchen staff to display a harmful foodstuff (step g8), and the kitchen staff changes the dish to a dish for harmful foodstuffs or prepares the food again (step g9). If the service staff recognizes that the food is on the right dish at step g7, and if the service terminal displays an indication that a harmful foodstuff is contained in the food, the service staff serves the food with telling the customers that a harmful foodstuff is contained in the food. When the staff finishes the servicing, the staff presses the service completion button on the service terminal (step g10).

In the embodiment, the display screen on the service terminal is also a touch panel. An indication that the food has been served is entered by a finger touch on an item that has been served on a service instruction screen in FIG. 25.

FIG. 26 is a flowchart of a feedback entry process at step a10 in FIG. 11.

In this example, a feedback screen is displayed on a display screen of a menu terminal at step a9 in FIG. 11. The feedback screen displays all the orders from the customers at the same dining table along with whether the user ordered the item or another customer at the dining table ordered the item.

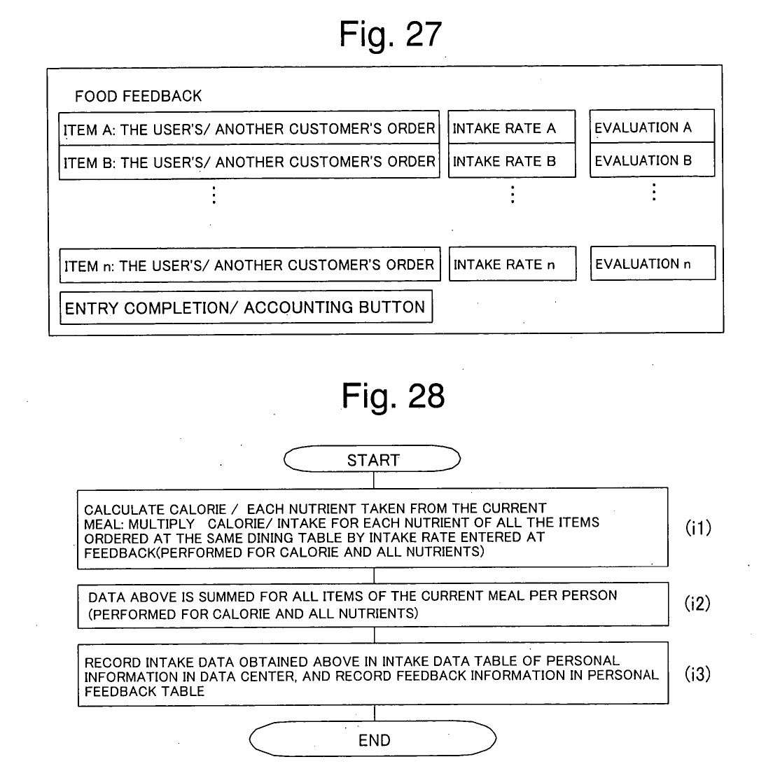

FIG. 27 is a diagram showing an exemplary feedback screen.

In this example, the items ordered by all the customers at the same dining table, who ordered the item: the user or the other customers (the other customers at the same dining table), intake rate input fields, evaluation input fields, and an entry completion/account button are displayed.

The user selects an intake rate field for the item he/she ordered and enters the amount he/she ate in the form of intake rate (step h1). The user also enters a score for evaluating the food (step h2). Though it is not illustrated here, a user can enter more detailed comments from a keyboard or the like on a menu terminal. When the user presses the entry completion/account button (step h3), entering of the feedback information is completed. As FIG. 26 illustrates user's manipulation, the system according to the embodiment processes the reception of the user's manipulation.

FIG. 28 is a flowchart of an updating process of personal data at step all in FIG. 11. In this example, a calorie intake and an intake for each nutrient from the current meal are calculated on the basis of the entered feedback information. The calorie intake and the intake for each nutrient for all the items ordered at the same dining table are multiplied by the intake rate entered by the user as feedback information (step i1).

The calorie intake and the intake for each nutrient are summed for all the items of the current meal (step i2). The intake data thus obtained is recorded in an intake data table (see FIG. 4) of personal data in a data center, and the feedback information is recorded in a personal feedback information table (see FIG. 1) (step i3).

The description of FIG. 11 in detail ends here.

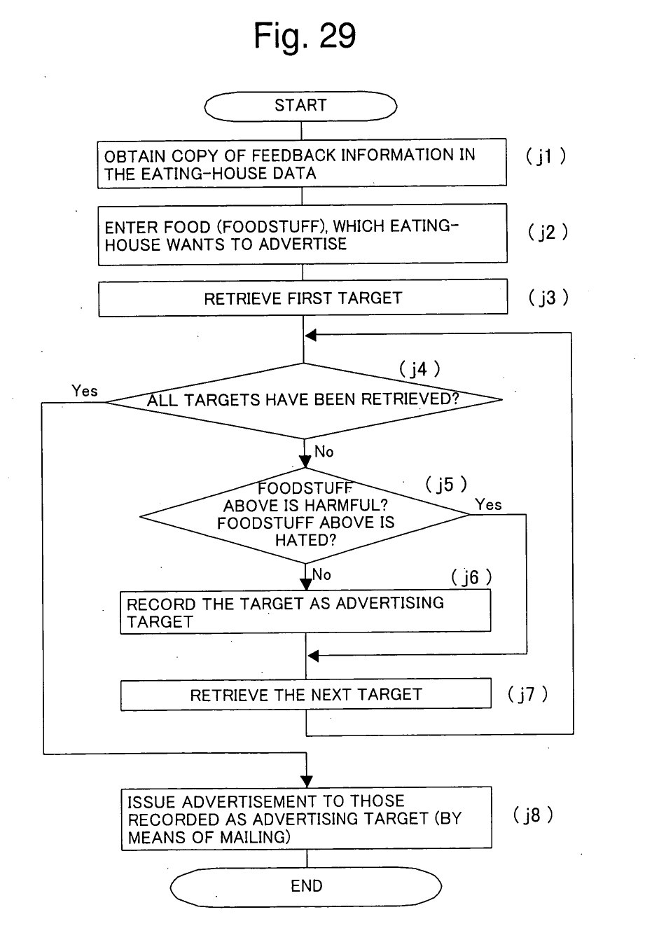

FIG. 29 is a flowchart illustrating an eating-house's advertising process.

In this example, a copy of feedback information (see FIG. 8) in an eating-house data is obtained (step j1). A food (foodstuff), which the eating-house currently wants to advertise, is entered (step j2).

The first target is retrieved from a copy of user information of the eating-house shown in FIG. 9 (step j3). Then determination is made whether all targets have been retrieved or not (step j4). When any target is left, determination is made whether the food (foodstuff) to be advertised for the retrieved targets contains a harmful foodstuff or a hated foodstuff for the target (whether the foodstuff is a harmful foodstuff or hated foodstuff to the target) (step j5). If the food contains neither a harmful foodstuff nor a hated foodstuff for the target, the target is recorded as an advertising target (step j6). Then the next target is retrieved (step j7). These steps are repeated for all the customers (targets) in a copy of user information of the eating-house shown in FIG. 9 (step j4). Advertisements are sent to those recorded as targets of the advertisement by means of mailing (step j8).

The above process makes it possible for the eating-house to avoid sending the advertisement to a person whose harmful foodstuff or hated foodstuff is contained in the advertised food. This will lead the eating-place's better repetition.

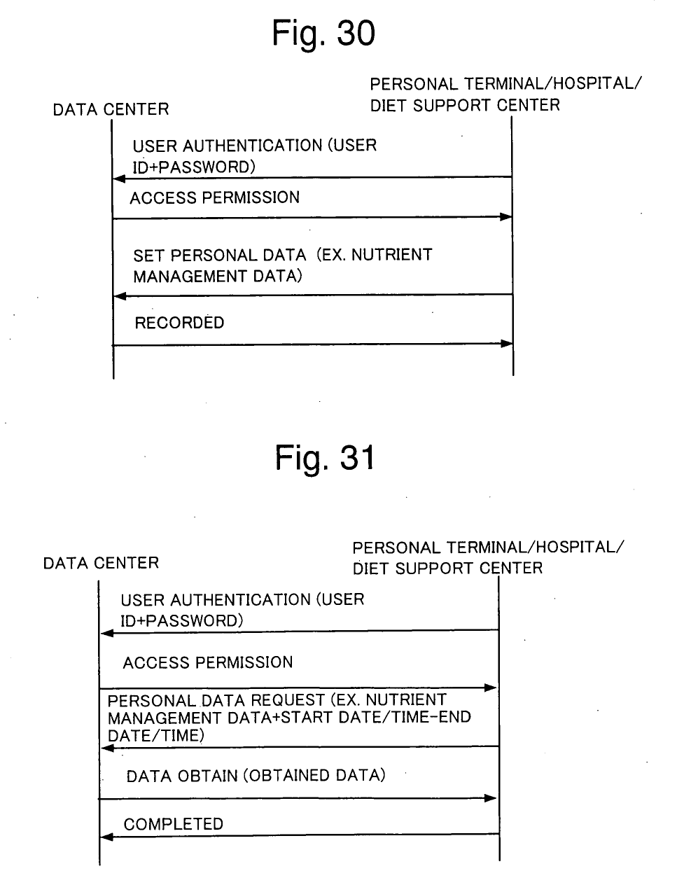

FIG. 30 is a diagram showing a setting procedure of personal data to a data center.

In the embodiment, any user new to this system has to set personal data in a data center first. The setting process of the personal data is performed in the procedure below.

First, a user ID and a password are sent to a data center for user authentication from a personal terminal owned by the user trying to set personal data or from a hospital terminal or a diet support center terminal that is used to set the data in place of the user. The terminal receives access permission from the data center and sends personal data, for example, nutrient management data (see FIG. 3) to the data center. The terminal receives a notice that personal data has been recorded from the data center and the personal data setting process ends. Even after a personal data is set, the data can be changed, if desired, by the same procedure as described above.

FIG. 31 is a diagram showing an obtaining procedure of personal data by a terminal outside an eating-house system, i.e., a personal terminal or a terminal placed at a hospital or diet support center.

Also in this example, a user ID and a password are sent from a terminal, which is used to obtain personal data, to a data center for user authentication first. The terminal receives access permission from the data center and issues a request to send personal data to the data center. In response, the data center sends the requested personal data to the terminal. The terminal obtains the personal data. When the data has been obtained, the terminal sends a notice that the data has been obtained to the data center.

In the embodiment, the data center and the person who join the system or a hospital or diet center that substitute the person communicates in this manner. The person can enter a calorie intake or an intake for each nutrient from a meal at home to ensure the health management. The hospital or diet support center can obtain the personal data to give a therapeutic or dietary advice on the basis of more accurate information.

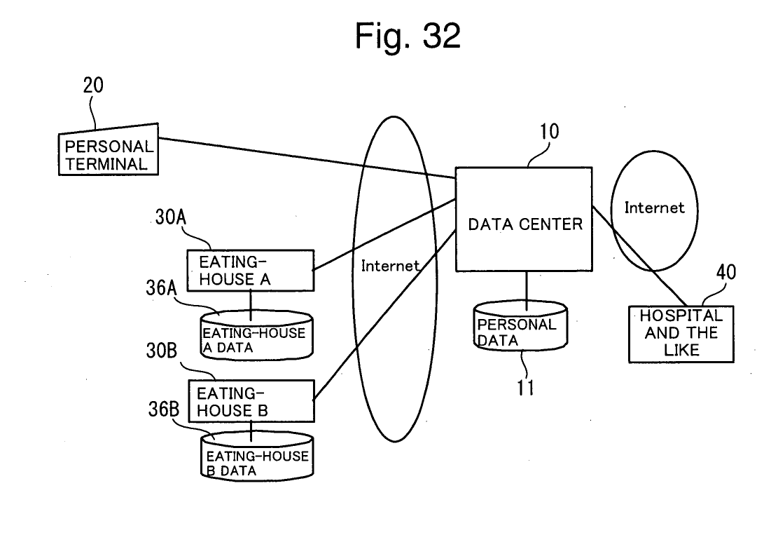

FIG. 32 is a diagram showing another embodiment of a menu-order selection support system according to the present invention. Its difference from the embodiment shown in FIG. 1 will be described.

In the embodiment shown in FIG. 1, a data center manages not only personal data but also eating-house data of each eating-house. In the embodiment shown in FIG. 32, personal data is managed at a data center as in the embodiment shown in FIG. 1, while eating-house data of each eating-house 36A and 36B are managed at eating-house system placed at each eating-house 30A and 30B.

Each eating-house can be more tightly protected against leakage of its trade secret in this manner.

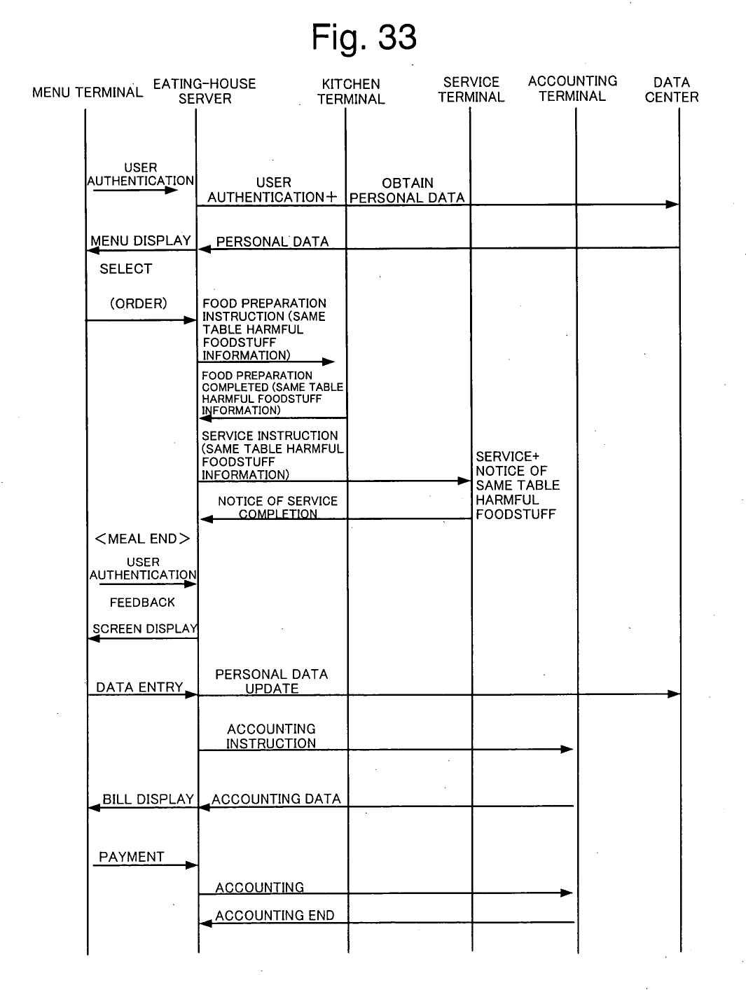

FIG. 33 is a diagram showing a procedure in the case of the system shown in FIG. 32 where each eating-house manages eating-house data of its own.

Its differences from the procedure shown in FIG. 12 are as follows. In the procedure shown in FIG. 12, the system obtains both personal data and eating-house data from a data center, while in the procedure shown in FIG. 33, the system obtains only personal data from a data center and uses eating-house data on an eating-house server. In the procedure shown in FIG. 33, after feedback information is obtained from a customer, it is only data for updating personal data that an eating-house server sends to a data center, and the eating-house data is updated on the eating-house server.

As the procedure described in FIG. 33 is the same as that described in FIG. 12 except those differences, redundant description will be omitted.

1. A menu-order selection support system comprising:
a data center that manages personal data including preference information indicating preference, harmful foodstuff information indicating a forbidden foodstuff, health management information for managing intakes, for each user, and provides the information in response to an access; and
an eating-house system that is connected to the data center via a communication line and provides, upon receiving personal data of a customer from the data center, the customer with a menu that matches the personal data of the customer.

2. The menu-order selection support system according to claim 1,
wherein the data center manages eating-house data including menu information that indicates ingredients and their contents in an item for each item on a menu at each eating-house along with the personal data, and
wherein the eating-house system provides, upon receiving personal data of a customer and eating-house data of its own from the data center, a menu that matches both the eating-house data of its own and the personal data of the customer.

3. The menu-order selection support system according to claim 1, wherein the eating-house system manages eating-house data of its own including menu information indicating ingredients and their contents in an item for each item on a menu and provides, upon receiving personal data of a customer from the data center, a menu that matches both the eating-house data of its own and the personal data of the customer.

4. The menu-order selection support system according to claim 1, wherein the eating-house system includes:
group recognition means for recognizing that a plurality of customers belong to the same group; and
warning means for warning, when a customer of a plurality of customers in a group orders an item containing a foodstuff harmful to a customer of the plurality of customers in the same group, that the harmful foodstuff is contained in the item.

5. The menu-order selection support system according to claim 2,
wherein the menu information includes optional information indicating a substitute for an ingredient of an item on a menu and a content of the substitute in the item, and
wherein the eating-house system provides a menu that matches personal data of a customer and is selected from the menu information including the optional information.

6. The menu-order selection support system according to claim 3,
wherein the menu information includes optional information indicating a substitute for an ingredient of an item on a menu and a content of the substitute in the item, and
wherein the eating-house system provides a menu that matches personal data of a customer and is selected from the menu information including the optional information.

7. The menu-order selection support system according to claim 1,
wherein the health management information includes information on an allowable intake and a previous intake for each of a plurality of durations with different time lengths, and
wherein the eating-house system provides a customer with an allowable intake for the customer's current meal calculated from the customer's previous intake and the allowable intake for the plurality of durations.

8. The menu-order selection support system according to claim 1, further comprising, in addition to the data center and the eating-house system, a terminal that records personal data in and/or uses personal data from the data center.

9. The menu-order selection support system according to claim 1, wherein the eating-house system comprises:
input means for inputting a customer's intake at the eating-house; and
feedback means for sending the intake input from the input means to the data center to update the customer's health management information.

10. The menu-order selection support system according to claim 1, wherein the eating-house system comprises:
input means for inputting a customer's evaluation of a current meal at the eating-house; and
feedback means for sending the input evaluation to the data center to update the customer's preference information.

11. The menu-order selection support system according to claim 1, wherein the eating-house system comprises:
visit information including preference information of the eating-house's customer in addition to the menu information;
input means for inputting a customer's evaluation of a current meal at the eating-house; and
feedback means for sending the input evaluation to the data center to update the customer's preference information and the visit information to the eating-house.

12. The menu-order selection support system according to claim 11, wherein the eating-house system comprises customer retrieval means for retrieving a target customer of the eating-house's advertisement on the basis of the visit information as to the eating-house.

13. A data center comprising:
data management means for managing personal data including preference information indicating preference, harmful foodstuff information indicating a forbidden foodstuff, and health management information for managing intakes, for each user; and
data providing means for providing customer's personal data in response to an access via a communication line from an eating-house system that provides a menu to a customer.

14. An eating-house system comprising:
data obtaining means for obtaining personal data of a customer from a data center by accessing the data center via a communication line, the data center managing personal data including preference information indicating preference, harmful foodstuff information indicating a forbidden foodstuff, and health management information for managing intakes, for each user; and
menu providing means for providing the customer with a menu that matches the personal data of the customer.
